(19) United States
(12) Patent Application Publication
(10) Pub. No.: US 2010/0223116 A1
(43) Pub. Date: Sep. 2, 2010

(54) Community Based Search and Revenue Allocation System and Method

(76) Inventor: Wen Chen Wu, Port Washington NY, NY (US)

Correspondence Address: STEVEN N. FOX, ESQ., P.O. BOX 251, CANTON, MA, 02021, US

(21) Appl. No.: 12/714,508

(22) Filed: Feb. 28, 2010

Related U.S. Application Data
(60) Provisional application No. 61/156,487, filed on Feb. 28, 2009.
(60) Provisional application No. 61/156,493, filed on Feb. 28, 2009.

(51) Int. Cl. G06Q 30/00; G06F 17/30; G06Q 50/00

(52) U.S. Cl. 705/14.16; 707/769; 707/E17.014

(57) ABSTRACT

The present invention is a web based search engine system and method for searching and displaying web based content from public web-sites and private remote computers of members connected to the Internet. In one embodiment, the system comprises a search query module adapted to accept a search query. The search query module comprises a first field for searching by key word and a second field for searching by purpose. The system further comprises a favorite list collection module adapted to upload favorite URLs from the remote computer of the member. The system further comprises a favorite list data base comprising a list of favorite URLs collected by the favorite list collection module. The system further comprises a generic search module adapted to search the Internet based upon the search query from the search query module. The system further comprises a favorite search module adapted to search said favorite list data base based upon the search query from the search query module. The system further comprises a first display list comprising generic URLs generated by the generic search module. The system further comprises a second display list comprising favorite URLs generated by the favorite search module. The system further comprises an advertisement module adapted to place a plurality of click-thru ads proximate the first display list of generic URLs and the second display list of favorite URLs. The system further comprises a revenue-sharing module adapted to assign credits to the members based upon activation of the click-thru ads by the users and friends invited by the users to determine a revenue-sharing rank for each member. The system further comprises a payment module adapted to transmit a payment to the members from advertising revenue according to the revenue-sharing rank of the members.

### CROSS-REFERENCE TO RELATED APPLICATIONS

This application claims priority to U.S. Provisional Application Ser. No. 61/156,487 filed on Feb. 28, 2009, now pending, and U.S. Provisional Application Ser. No. 61/156,493 filed on Feb. 28, 2009, now pending, both of which are hereby incorporated by reference in its entirety into this specification.

### BRIEF DESCRIPTION OF THE DRAWINGS

FIG. 1 is a high level block diagram showing the web based environment of the search engine web site according to the present invention;

FIG. 2 is a high level flow chart showing a method of operation of the web based environment of the search engine web site according to the present invention; and

FIG. 3 is a high level block diagram showing a display list generated by the search engine web site according to the present invention.

### SUMMARY OF THE INVENTION

The present invention is a web based search engine system and method for searching and displaying web based content from public web-sites and private remote computers of members connected to the Internet. In one embodiment, the system comprises a search query module adapted to accept a search query. The search query module comprises a first field for searching by key word and a second field for searching by purpose. The system further comprises a favorite list collection module adapted to upload favorite URLs from the remote computer of the member. The system further comprises a favorite list data base comprising a list of favorite URLs collected by the favorite list collection module. The system further comprises a generic search module adapted to search the Internet based upon the search query from the search query module. The system further comprises a favorite search module adapted to search said favorite list data base based upon the search query from the search query module. The system further comprises a first display list comprising generic URLs generated by the generic search module. The system further comprises a second display list comprising favorite URLs generated by the favorite search module. The system further comprises an advertisement module adapted to place a plurality of click-thru ads proximate the first display list of generic URLs and the second display list of favorite URLs. The system further comprises a revenue-sharing module adapted to assign credits to the members based upon activation of the click-thru ads by the users and friends invited by the users to determine a revenue-sharing rank for each member. The system further comprises a payment module adapted to transmit a payment to the members from advertising revenue according to the revenue-sharing rank of the members.

### DETAILED DESCRIPTION OF THE INVENTION

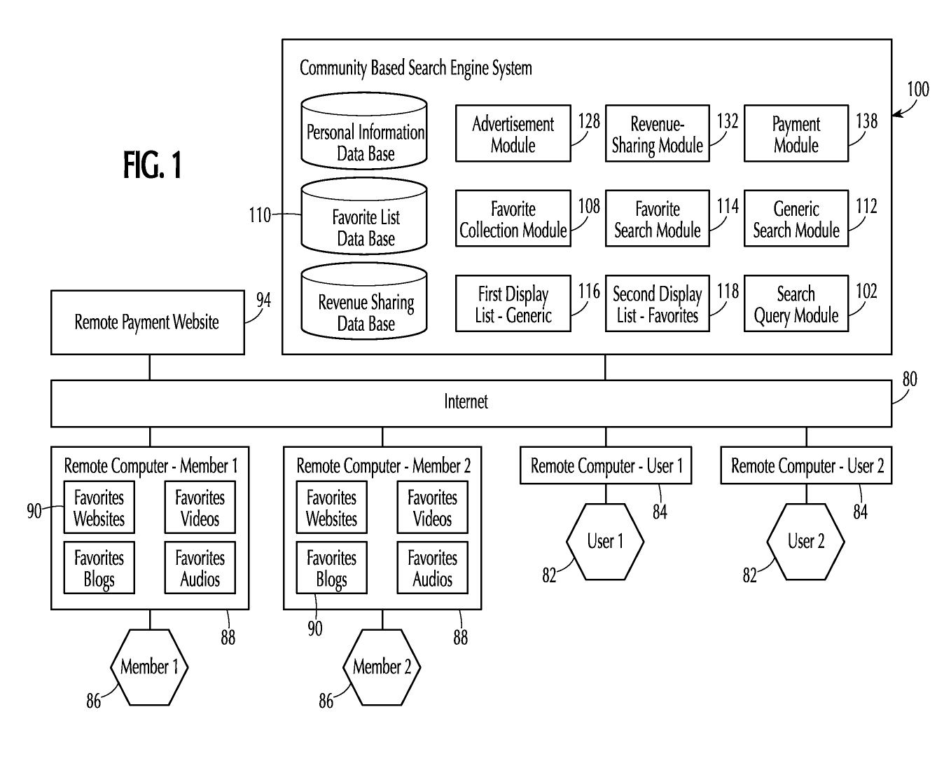

Referring to FIG. 1, the present invention is a community based search engine system 100 connected to the Internet 80 that can be operated by users 82 having remote computers 84 to search and display content from public web-sites and/or remote private computers 88 controlled by members 86 of system 100. In one embodiment, system 100 comprises a search query module 102 adapted to receive a search query from users 82. Search query module 102 comprises a first field 104 for searching by common key word and a second field 106 for an auxiliary statement of purpose. This increases the likelihood of more data inputted and results in better more relevant search results. System 100 further comprises a favorite list collection module 108 adapted to upload favorite URLs 90 from remote computers 88 of members 86. Favorite URLs 90 may be web-sites, blog sites, video, and/or audio files. Favorite URLs may be those files and/or URLs that have been “saved” as such in a computer while browsing on-line and captured in a file within a computer during browsing. System 100 further comprises a favorite list data base 110 comprising a list of favorite URLs collected by favorite list collection module 108. System 100 further comprises a generic search module 110 adapted to search the Internet using the search query from first field 104 and second field 106. Generic search module 110 may use a variety of well known search algorithms employed by conventional search engines such as Google, Yahoo or Alta Vista. System 100 further comprises a favorite search module 114 adapted to search favorite list data base 112 using the, search query from first field 104 and second field 106. Favorite search module 110 is limited to favorite list data base 110. System 100 further comprises a first display list 116 comprising generic URLs generated by generic search module 112. System 100 further comprises a second display list 118 comprising favorite URLs generated by favorite search module 114. Second list display 118 may comprise a list 120 of favorite web-sites, a list 122 of favorite videos, a list 124 of favorite audios, and a alist 126 of favorite blogs. System 100 further comprises an advertisement module 128 adapted to place a plurality of click-thru ads 130 proximate first display list 116 of generic URLs and second display list 118 of favorite URLs. System 100 further comprises a revenue-sharing module 132 adapted to assign credits 134 to members 86 based upon activation of click-thru ads 130 by the users 82 as well as the number of “friends” invited by users, to determine a revenue-sharing rank 136 for each member 86. System 100 further comprises a payment module 138 adapted to transmit a payment to members 86 from advertising revenue according to the revenue-sharing rank 136 of each member 86.

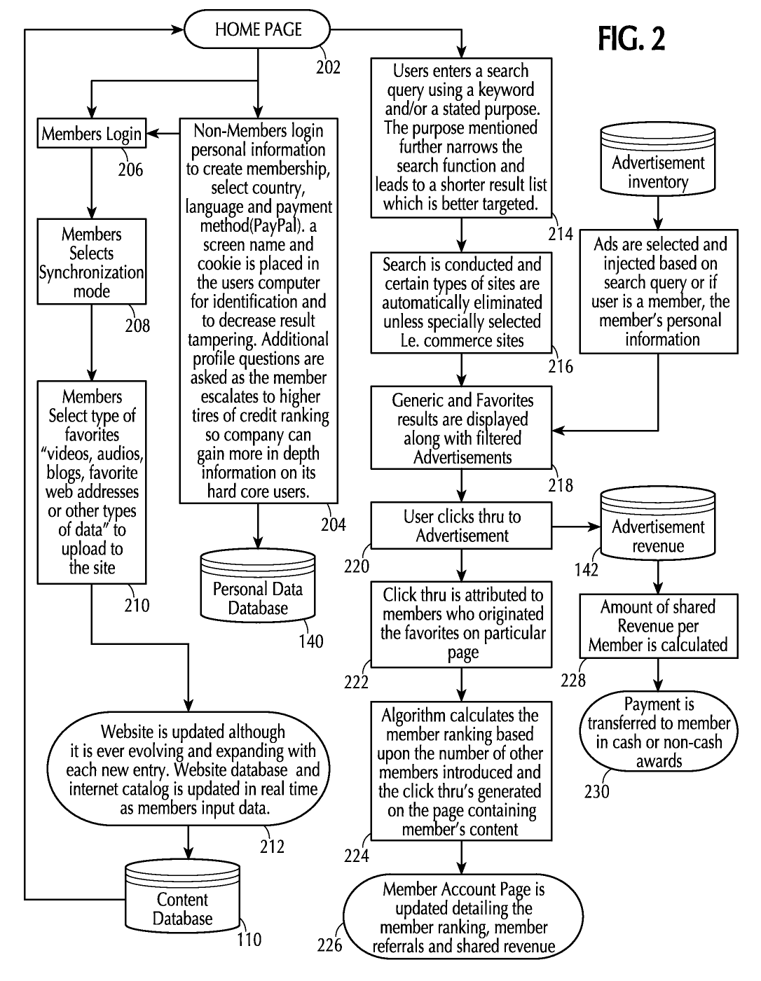

Referring to FIG. 2, home page of system 100 is indicated by step 202. As shown by step 204, a non-member may register with system 100 by clicking a registration button (not shown) and entering personal information as prompted by system 100 to create a membership. Personal information, includes but is not limited to, country, language, payment method (such as PayPal), selection of a screen name. System 100 places cookie in the member's computer for identification and to decrease result tampering. System 100 may prompt the member for additional information as the member escalates to higher tiers of credit ranking so the system can gain more in depth information on members that use system often. As shown by block 140, personal information is stored in personal data base 140. As shown by step 206, a member logs into system 100 by entering his/her screen name and password. As shown by step 208, the member may select a synchronization mode between the system and the member's computer thereby allowing system 100 to download information from the member's computer. As shown by step 210, the system 100 prompts the member to select the type of favorite content to be uploaded to system 100 such as favorite web sites addresses, favorite videos, favorite audios, favorite blogs, or other some of content. As shown by step 212, the favorite content is uploaded by favorite collection module 108 and stored in favorite list data base 110.

As shown by step 214, a user (a user may or may not be a member) may use system 100 for searching and display content by entering a search query using a keyword and a stated purpose. In particular, the user enters one or more keyword into first search field 104 indicative of a general search and one or more keywords into second search field 106 indicative of a stated purpose. As shown by step 216, system 100 executes the search and certain types of web-sites such as commerce sites) are automatically eliminated unless specifically selected. Generic search module 112 searches the entire Internet 80. Favorite search module 114 searches favorite data base list 110. Given a plurality of separate an distinct text search boxes, users will enter more data than if presented with only one text box thereby obtaining a better the search quality. As shown by step 218, system 100 stores and displays the search results in a first display list 116 of generic search results and a second display list 118 of favorites results. Advertisement module 129 inserts a plurality of click-thru ads 130 in close proximity to display lists 116 and 118. As shown by step 220, upon clicking of a click-thru ad 130 by the user, the the URL corresponding to the click-thru ad is displayed and advertising revenue generated by the click-thru is added to advertising revenue data base 142. As shown by step 222, the click-thru is attributed to each member who originated the content appearing on first display list 116 and second display list 118. As shown by step 224, system 100 calculates a given member's ranking based upon the number of click-thru's attributed to the given member and the number of other members introduced or referred to system 100 by the given member. As shown by step 226, the member's account page is updated detailing the member's ranking, member referrals, and shared revenue. As shown by step 228, system 100 determines the amount of shared revenue for each member. This may be done on a periodic basis such as weekly, monthly, or quarterly. As shown by step 230, system 100 transmits or sends a payment to each member using remote payment website 94 which may be PayPal.

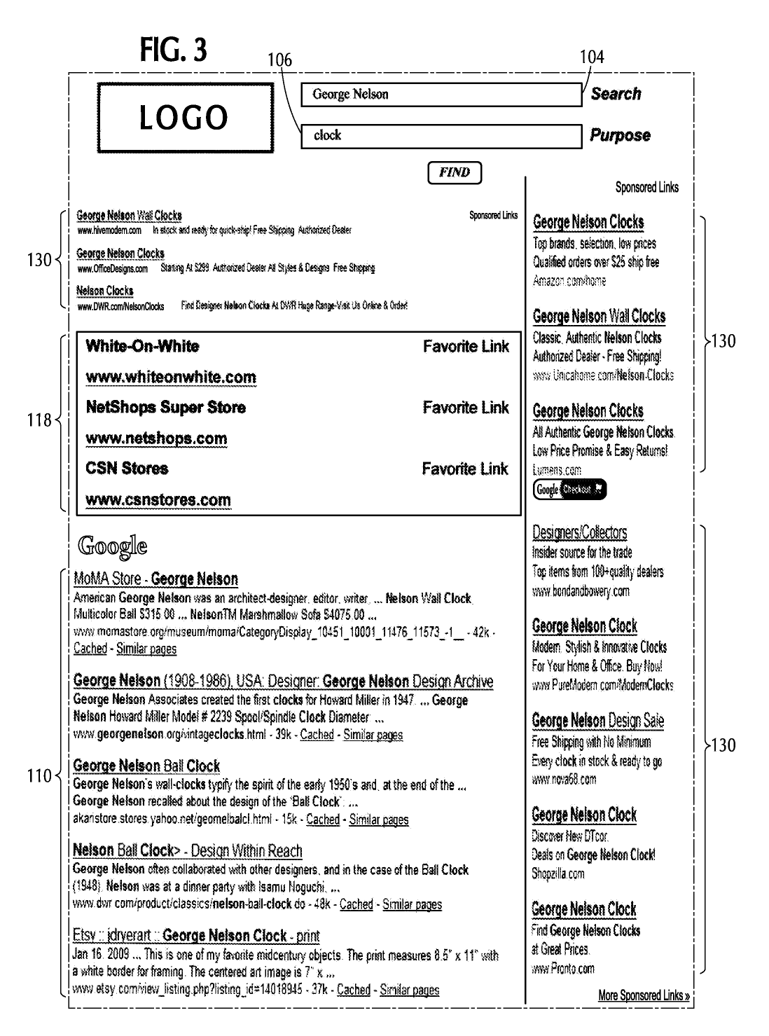

Referring to FIG. 3, where a search page of system 100 is shown comprising first and second search fields 104 and 106; first display list 116 of generic URLs; second display list 118 of favorite URLs; and click-thru ads 130. In the example of FIG. 3, the user is interested in locating web-sites having information regarding clocks by a specific designer, namely, George Nelson. The user has entered the name of the designer, namely, “George Nelson,” into first search field 104 and the term “clock” into second search field 106. Searching of internet 80 using these terms resulted in first display list 116 which is a list of generic URLs. Searching of favorite list data base 110 resulted in second display list 118 which is a list of favorite web-sites entered into system 110 by one or more members. Click-thru ads 130 are displayed above second display list 118 and along the right side of first and second display list 116 and 118. The advertising revenue generated by a user clicking any click-thru ad 130 is shared among all members that originated the favorite links appearing on that page as described heretofore, and then paid to the members on a periodic basis.

The foregoing description is intended for purposes of illustration. The invention may be embodied in other forms or carried out in other ways without departing from the spirit or scope of the invention.

What is claimed:

1. A search engine system for searching and displaying web based content from public web-sites and private remote computers of members connected to the Internet, the system comprising:
(a) a search query module adapted to accept a search query; said search query module comprising a first field for searching by key word and a second field for searching by purpose;
(b) a favorite list collection module adapted to upload favorite URLs from the remote computer of the member;
(c) a favorite list data base comprising a list of favorite URLs collected by said favorite list collection module;
(d) a generic search module adapted to search the Internet based upon said search query from said search query module;
(e) a favorite search module adapted to search said favorite list data base based upon said search query from said search query module;
(f) a first display list comprising generic URLs generated by said generic search module;
(g) a second display list comprising favorite URLs generated by said favorite search module;
(h) an advertisement module adapted to place a plurality of click-thru ads proximate said first display list of generic URLs and said second display list of favorite URLs;
(i) a revenue-sharing module adapted to assign credits to the members based upon activation of said click-thru ads by the users and friends invited by the users to determine a revenue-sharing rank for each member; and
(j) a payment module adapted to transmit a payment to the.members from advertising revenue according to said revenue-sharing rank of the members.

2. The system of claim 1, wherein said revenue-sharing module is adapted to assign credits to the members based upon activation of said click-thru ads and referrals when determining said revenue-sharing rank for each member.

3. The system of claim 2, wherein said list of generic URLs is a list of web-sites.

4. The system of claim 3, wherein said list of favorite URLs is a list of web-sites.

5. The system of claim 4, wherein said list of favorite URLs is a list of video.

6. The system of claim 5, wherein said list of favorite URLs is a list of music.

7. The system of claim 6, wherein said list of favorite URLs is a list of blogs.

8. The system of claim 7, wherein said list of favorite URLs is a list of pictures.
